(19) United States
(12) Patent Application Publication
(10) Pub. No.: US 2004/0221305 A1
(43) Pub. Date: Nov. 4, 2004

(54) Apparatus, method and computer programming product for cable TV service portability

(75) Inventors: Scott J. Broussard, Cedar Park, TX (US); Michael Wayne Brown, Georgetown, TX (US); Eduardo N. Spring, Round Rock, TX (US)

Correspondence Address: Leslie A. Van Leeuwen, International Business Machines Corporation, Intellectual Property Law Department, Internal Zip, 11400 Burnet Road, Austin, TX, 78758, US

(73) Assignee: International Business Machines Corporation, Armonk, NY

(21) Appl. No.: 10/427,136

(22) Filed: Apr. 30, 2003

(51) Int. Cl. H04N 7/173; G06F 13/00; H04N 5/445

(52) U.S. Cl. 725/38; 725/52; 725/120; 725/109

(57) ABSTRACT

According to one aspect of the present invention a method for selectively transportable TV services to a subscriber includes a first TV services provider receiving a request from the subscriber. The request identifies a selected set of predefined channels and a selected converter located at a location to which the selected set is to be redirected. Responsive to the request, or as part of the request, a second TV services provider serving the selected converter is identified. A second request is sent to the second provider identifying the selected channels to be redirected to the converter. The second provider responsively identifies which ones of the channels of the selected set are available for delivery by the second provider to the converter. A comparison of these available channels to the selected channels indicates whether all of the selected channels are available for delivery by the second provider.

### BACKGROUND

1. Field of the Invention

The present invention relates to systems and methods of targeted delivery of cable television subscriber services over networks such as the Internet.

2. Related Art

A vast number of households subscribe to cable television (“TV”) and/or satellite TV services offered by various TV entertainment service providers. The TV services offered generally include a multitude of channels, each providing distinctive program content to a subscriber. The present provider/consumer business model is based on delivering TV entertainment services to the subscriber's home or an apartment. Specifically, the subscriber (also referred to herein as a “consumer”) signs a contract with a local cable or satellite services provider to receive TV services at a particular location, generally identified by a street address, and for a predetermined number of TV receivers located at the particular address. The subscriber, typically subscribes to a list of channels selected from a list of available channels, and agrees to pay a fee for receiving the subscribed channels. The TV services provider often provides converters to deliver the TV signal to each of the predetermined number of TV receivers located at the particular address.

Present delivery systems for TV entertainment services are problematic in some respects. For example, when the subscriber is away from home, the subscriber does not have access to the service for which the subscriber has already paid. A present solution is for the subscriber to inform the cable or satellite TV service provider to temporarily suspend the delivery of the service while the subscriber is away from home, and request credit for that duration. Another solution is for the subscriber to not suspend the service and to buy it at a new location while away from home, thus paying twice.

From the above it should be appreciated that conventional delivery systems for TV services are currently unable to provide practical and cost effective solutions to the subscriber, and that there is a need for improvements.

### SUMMARY OF THE INVENTION

The forgoing need is addressed by the present invention, according to one aspect of which a method for selectively transportable TV services to a subscriber includes a first TV services provider receiving a first request from the subscriber. (This request may be sent to the first provider through another provider.) The first request identifies a selected set of predefined channels and a selected converter located at a location to which the selected set is to be redirected. Responsive to the request, or as part of the request, a second TV services provider serving the selected converter is identified. A second request is sent to the second provider identifying the selected channels to be redirected to the converter. The second provider responsively identifies to the first provider which ones of the channels of the selected set are available for delivery by the second provider to the converter. A comparison of these available channels to the selected channels indicates whether all of the selected channels are available for delivery by the second provider.

It is advantageous that the invention allows a consumer of TV services to redirect or forward at least a portion of the subscribed and paid for services. Additional aspects, objects, advantages and other forms of the invention will become apparent upon reading the following detailed description and upon reference to the accompanying drawings.

### BRIEF DESCRIPTION OF THE DRAWINGS

FIG. 1 illustrates a block diagram of components included in a TV services delivery system, according to one embodiment of the present invention.

FIG. 2A is a flow chart illustrating a method for redirecting at least a portion of the subscribed TV services, according to an embodiment of the present invention.

FIG. 2B is a flow chart illustrating a method for preparation of the service request described in FIG. 2A, according to an embodiment of the present invention.

FIG. 3 illustrates a block diagram of components of a communications protocol supported by the TV services delivery system, according to an embodiment of the present invention.

FIG. 4 is a computer system appropriate for implementing one or more embodiments of the present invention of the present invention.

### DETAILED DESCRIPTION OF A PREFERRED EMBODIMENT

The claims at the end of this application set out novel features which applicant believes are characteristic of the invention. The invention, a preferred mode of use, objectives and advantages, will best be understood by reference to the following detailed description of an illustrative embodiment read in conjunction with the accompanying drawings.

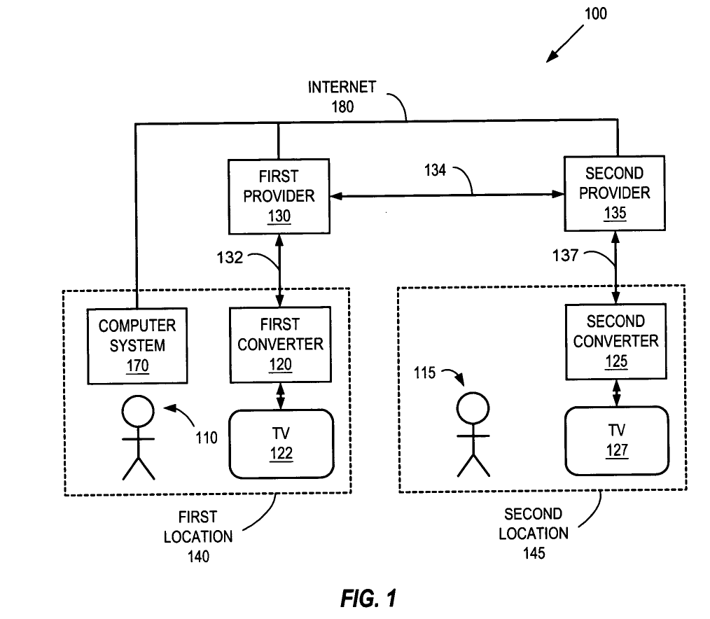

Referring to FIG. 1, a block diagram illustrating components included in a TV services delivery system 100 are shown, according to one embodiment of the present invention. The TV services delivery system 100 is operable to deliver TV services so that the consumer has the freedom to selectively redirect at least a portion of the subscribed services to another location of choice, on an on-demand or scheduled basis.

Components of the TV services delivery system 100 for a subscriber 110 include a first converter 120 located at first location 140, typically the subscriber's home. The converter 120 is operable to receive a signal that includes TV programs or other content arranged by channels from a first provider 130 via a first communications link 132 and to convert the signal to a format for a TV set 122 coupled to the converter 120. In this manner the TV set 122 is operable to display subscribed TV channels. (It should be understood that the converter 120 may be included in the TV set 122. It should also be understood that there may be more than one TV set 122 and corresponding converter 120 at the location 140.) The subscriber 110 has an agreement with the first provider 130 to receive and pay for TV services at the first location 140, including a set of channels (also referred to as subscribed channels) that the subscriber has selected from a list of available channels.

Shown at second location 145 is a traveling subscriber 115, which may or may not be the same individual as subscriber 110. For example, the traveling subscriber 115 may be a member of the household from the first location, and the first subscriber 110 may still be at the home location 140. At the second location is a second converter 125, like the first converter 120, coupled to one or more second TV sets 127 and to a second provider 135 via a second communications link 137. (It should be understood that at the location 145, as at the first location 140, the converter 125 may be included in the TV set 127 and there may be more than one TV set 127 and corresponding converter 125.) The TV services delivery system 100 may include other providers (not shown) and their respective networks (not shown) in addition to the providers 130 and 135 shown.

The TV services delivery system 100 in the depicted embodiment also includes a computer system 170 at the first location 140 coupled to the providers 130 and 135 via the Internet 180. The computer system or systems 170 may be included in the corresponding converter or TV set, and in such a case may communicate to a provider via the same link 132 that carries the TV signal. There may also be such a system 170 at the second location 145, and in such a case the system 170 may communicate to a provider via the same link 137 that carries the TV signal. There is also a computer system (not shown) for the first provider 130 and a computer system (not shown) for the second provider 135, programmed to perform applicable steps described herein.

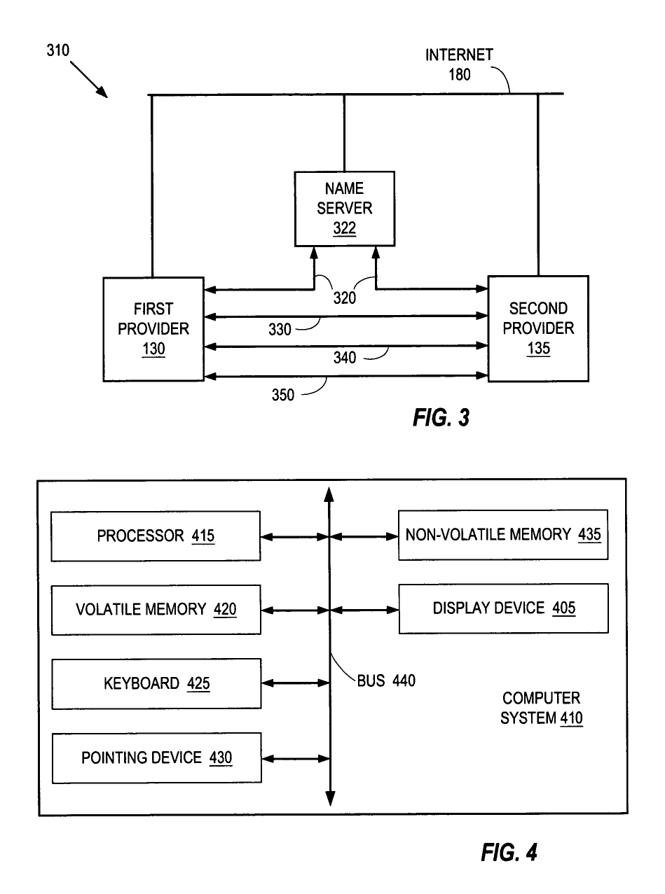

Also shown is a third communications link 134 coupling the providers 130 and 135. The communications links 132, 134 and 137 may include broadband communication media such as coaxial cable, satellite, DSL, fiber optic and similar other high speed media. In one embodiment, the communications links 132, 134 and 137 may include or even be the same as the Internet 180. Each of the converters 120 and 125 has a tag that uniquely identifies the converter within the first provider 130 and second provider 135 networks respectively. Alternatively, the TV sets 122 and 127 may have the tags. A communications protocol is defined for exchanging information between various elements of the TV services delivery system 100. For example, the first provider 130 uses a component of the communications protocol to communicate with the subscriber 110 using the communications link 132. Additional details of the communications protocol are described in FIG. 3 further below.

The above arrangement is used in providing a selectively transportable method and system for providing TV services to the subscriber(s) 110 and 115, according to which the first TV services provider 130 receives a first request from the subscriber 110 or 115. (This request may be sent to provider 130 through another provider, such as provider 135.) The first request identifies a selected set of ones of the predefined channels and a selected converter 125 located at the second location 145 to which the selected set is to be redirected. Responsive to the request, or as part of the request, a second TV services provider 135 serving the selected converter 125 is identified. A second request is also sent to the second provider 135 identifying the selected channels to be redirected to the converter 125. The second provider 135 responsively identifies to the first provider 130 which ones of the channels of the selected set are available for delivery by the second provider 135 to the converter 125. A comparison of these available channels identified by the provider 135 to the selected channels indicates whether all of the selected channels are available for delivery by the second provider 135, i.e., whether any of the selected channels are not available for delivery.

More specifically, the subscriber 110 selects a set of channels to redirect and instructs the first provider 130 to redirect the selected set of ones of the subscribed channels (referred to herein as “redirected” channels) from the first location 140 to the second location 145 on an on-demand or scheduled basis. The subscriber 110 includes in the instruction to the provider 130 a ranking of the redirected channels indicating which of the channels the subscriber 110 values the most. This is in case not all the channels can be redirected due to unavailability of the channels from a second provider 135 and lack of bandwidth for transferring the channels from the first provider to the second provider.

The subscriber 110 may instruct the first provider 130 by a variety of means. According to one arrangement, the subscriber 110 uses a telephone network (not shown) to authenticate the redirection request and instruct the first provider 130 to redirect the channel(s). In another case, the subscriber 110 uses the computer system 170 to instruct the first provider 130 via the Internet 180. In this case, a secure communications protocol may be used to authenticate the subscriber 110 and instruct the first provider 130. The well-known Secure Sockets Layer (‘SSL’) protocol is an example of such a secure communications protocol. In yet another instance, the subscriber 110 uses the first converter 120 and a channel included in the first communications link 132, i.e., in the link 132 which carries the TV signal, to instruct the first provider 130. In still another aspect, the subscriber 110 utilizes a smart card (not shown) operable to authenticate the redirection request and instruct the first provider 130. The provider 130 may communicate with the smart card for this purpose either via the computer system 170 or the first converter 120, according to the embodiment. In addition to smart cards, other forms of authentication techniques such as cryptographic techniques using digital signatures may also be used.

On receiving the instructions from the subscriber 110 to redirect at least a portion of the subscribed channels from first location 140 to second location 145, the first provider 130 contacts the second provider 135 using the communications link 134. In one embodiment, the first provider 130 accesses a database (not shown) to find the provider 135. (It should also be understood that there may be more than one provider of TV services for the second location 145.) The database may be located internally and/or externally to the first provider 130.

The first provider 130 then queries the second provider 135 servicing the second location 145 to determine the feasibility of the redirection request. That is, the channel content and program content of the channels included in the TV services delivered by the providers 130 and 135 respectively within their networks (not shown) may vary. Consequently, the second provider 135 may not be able to provide the channels requested.

Once redirected, the redirected channels are only be available at second location 145. That is, the first converter 120 continues to receive all the subscribed channels except for the redirected channels. Any number of fee arrangements are possible. In general terms, however, the invention enables an arrangement according to which the subscriber 110 pays only the original subscription fee and receives only the channels to which the subscriber 110 originally subscribed, but some of the channels are received at the first location 140 and some are received at the second location 145. Of course, the original subscription service fee may include a fixed fee for the redirection service, or there may be a redirection service fee for each use of the service. The providers 130 and 135 may share the fee based on prior revenue sharing agreements, etc.

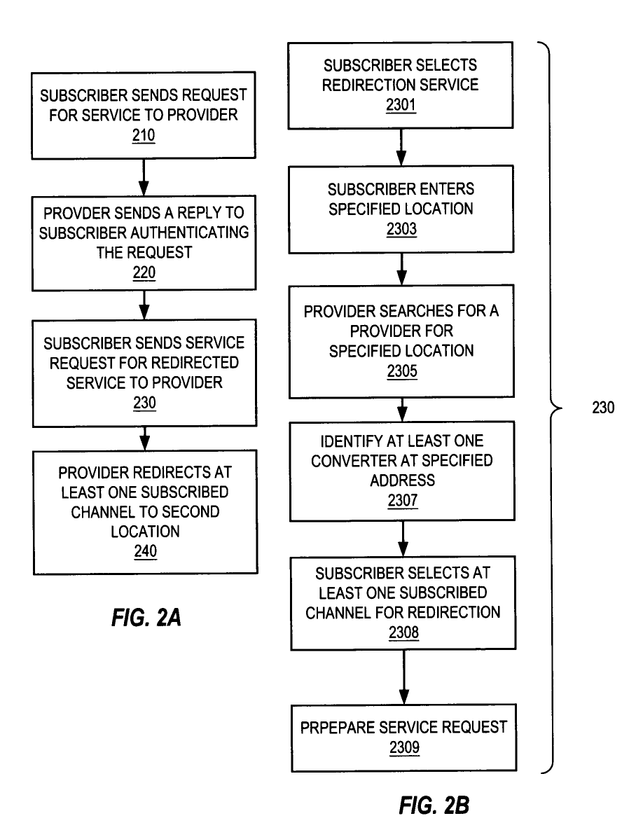

In one embodiment, the instructions to redirect at least a portion of the subscribed channels from the first location 140 to the second location 145 are received from the traveling subscriber 115 located at second location 145. The redirection request may be communicated by telephone, via the Internet 180, or other means, as described earlier. In another embodiment, the subscriber 110 sends the redirection request from the first location 140 while the traveling subscriber 115 is located at second location 145, or sends an instruction from the first location 140 authorizing the traveling subscriber 115 to submit further instructions about redirection. Further details of redirecting at least a portion of the subscribed services are described in FIGS. 2A, 2B and 3, and in Tables 1 through 3.

Referring to FIG. 2A, a flow chart illustrating a method for redirecting at least a portion of the subscribed TV services is shown, according to an embodiment of the present invention. With reference also to FIG. 1, in step 210, the subscriber 110 sends a request for service to the first provider 130. For example, the subscriber 110 does this using the computer system 170 and the Internet 180 to log on and access the home page of the first provider 130, as has been described above. In step 220, the subscriber 110 receives a reply from the first provider 130 authenticating the subscriber's request for service.

In step 230, a service request is sent to a provider servicing the specified location, e.g., the second provider 135 servicing second location 145. The service request includes information describing the unique address of at least one specified converter, e.g., the second converter 125, and the at least one redirected channel. Further details of the service request are described in FIG. 2B.

In step 240, on receiving validation regarding the feasibility of redirecting the channel or channels to the specified converter, the first provider 130 redirects the content of the at least one redirected channel to the specified converter, e.g., the second converter 125. In one embodiment, to conserve bandwidth, the first provider 130 redirects the content of only those channels selected for redirection that are not available from the second provider 135. Accordingly, if the second provider 135 is able to provide to the second converter 125 all channels selected for redirection then the first provider 130 does not transfer the program content of any channels to the second converter 125.

Referring to FIG. 2B, a flow chart illustrating a method for preparation of the service request described in step 230 is shown, according to an embodiment of the present invention.

With reference also to FIG. 1, in step 2301, the subscriber 110 selects a redirection service from a list of provider-offered services. In one embodiment, the list is generated by a graphical user interface (‘GUI’) displayed by the computer system 170 in communication with the provider 130.

In step 2303, in response to selecting the redirection service the system 170 prompts the subscriber 110 to enter the location 145 to which the service will be redirected. In one embodiment, the subscriber 110 may specify the second location 145, by providing specified location's attributes such as address, city, zip code, and/or phone number.

In step 2305, responsive to receiving information describing the second location 145 the first provider 130 searches a database to determine at least one provider 135 providing TV services to the specified location. The nature of this database will be described further herein below in connection with FIG. 3.

In step 2307, at least one converter box located at the specified location and having a unique tag is identified. One or more converters may be available for subscriber selection at the specified location. In one circumstance, the subscriber 110 or 115 may provide a unique address or tag number of the second converter 125 located at second location 145 that is capable of receiving the redirected TV services. This may be the case, for example, if the subscriber 115 is in a hotel room at the second location 145 and the room has a converter 125 labeled with the unique tag. In another circumstance, the first provider 130 queries the database or the second provider 135 for a list of valid unique addresses for converters 125 available at second location 145 that are capable of receiving the redirected TV services. The subscriber 110 then selects at least one of the address.

In step 2308, the subscriber 110 selects at least one channel from the subscribed channel list that is to be redirected to the second location 145.

In step 2309, the service request is prepared, including the unique address of the specified converter 125 identified in step 2307 and the one or more redirected channels identified in step 2308.

Various steps of FIGS. 2A and 2B may be added, omitted, combined, altered, or performed in different orders. For example, in one embodiment, step 230 in FIG. 2A may be split into two sub steps, according to which in the first sub step the service request is prepared as described in FIG. 2B and in the second sub step the service request prepared in step 230A is sent to second provider 135.

As an option or in addition to using the Internet 180 for accessing information about available redirection facilities and communicating the redirection instructions, the subscriber 110 or 115 may use a telephone based user interface for the same purpose. Referring to FIG. 3, and with reference also to FIG. 1, a block diagram illustrating components of a communications protocol 310 supported by the TV services delivery system 100 are shown, according to one embodiment of the present invention. As described earlier, the communications protocol 310 defines a structure or a format for exchanging information between various elements of the TV services delivery system 100. In this embodiment, the FIG. 1 illustrated communications links 132, 134, 137 and the Internet 180 included in the TV services delivery system 100 use components of the communications protocol 310 depicted in FIG. 3. The communications protocol 310 shown includes 4 components: provider name service 320, subscriber identity protocol 330, content deliver protocol 340, and content billing protocol 350.

As described in connection with step 2305 of FIG. 2B, the first provider 130 accesses a database to locate one or more providers 135 providing TV services to the second location 145. In one embodiment, the provider name service 320 provides access to this database. Specifically, the database resides on a name server 322 accessed by the provider name service 320. The server 322 is coupled to the Internet 180 and includes software to the provider name service. The service 320 provides a communication link from the providers to the server 322.

In an embodiment, the provider name service 320 utilizes well-known naming services such as Java Naming and Directory Interface™ (‘JNDI’) or the CORBA name service and is hosted and synchronized from time to time by several TV service providers in the industry, so that all service providers are able to lookup contact information for other service providers.

The subscriber identity protocol 330 is used by a provider within the TV services delivery system 100 to authenticate a subscriber. For example, the first provider 130 uses the subscriber identity protocol 330 to authenticate the subscriber 110 during a sign-on process described in step 210 of FIG. 2. The subscriber identity protocol 330 is also used by a provider to authenticate a traveling subscriber. For example, the first provider 130 uses the subscriber identity protocol 330 to initially locate the second provider 135 (e.g., by using the provider name service 320) and then authenticate the traveling subscriber 115. Authentication of the traveling subscriber 115 may include validating the second converter 125 at second location 145.

The content delivery protocol 340 is used by a subscriber within the TV services delivery system 100 to redirect at least a portion of the subscribed channels to the specified location as described in steps 230 and 240 of FIG. 2. For example, the first provider 130 uses the content delivery protocol 340 to process any or all of the following steps. The provider 130 determines which channels the subscriber is selecting for redirection to the specified location and which of those selected channels the provider 135 is able to supply to the second location 145. If the second provider 135 is able to provide all of the redirected channels then there is no need for the first provider 130 to transfer the program content for any redirected channel, but if the second provider 135 is not able to provide all of the redirected channels, then the first provider 130 checks for available bandwidth of the communications link 134 to transfer program content. That is, the provider 130 determines bandwidth required to send the selected channels and responsively determines a certain minimum bandwidth limit in comparison to the bandwidth required. The provider 130 then checks to see if available bandwidth is below the certain limit. If sufficient bandwidth is available, the first provider 130 transfers the program content of the redirected channels that are not being provided by the second provider 135. If sufficient bandwidth is not available to make up the entire difference, the first provider 130 may transfer some of the channels that are not being provided by the second provider 135, as bandwidth permits. In this case, the first provider 130 may also notify the subscriber 110 of the limitation.

The subscriber 110 is billed by the first provider 130 for providing the redirected services. The content billing protocol 350 described below is used to transfer billing information with other providers such as the second provider 135.

Various steps described above may be added, omitted, combined, altered, or performed in different orders. For example, as an alternative, if the second provider 135 is not able to provide all of the redirected channels to the subscriber 110 then a set of replacement channels are offered. The subscriber 110 may accept or reject the replacement channels and the billing is adjusted using the content billing protocol 350 described below.

The content billing protocol 350 is used by a provider within the TV services delivery system 100 to keep track of billing information associated TV services, especially with the redirection service. For example, first provider 130 uses the content billing protocol 350 to determine the total charges to be billed to the subscriber 110 for the redirection service. The total charges may be dependent on factors such as the number of channels redirected, the type of channel redirected, the number of replacement channels selected, the time duration of the redirection service, the specified location, number of converters receiving the redirected channels and prior revenue sharing agreements with other providers within the TV services delivery system 100.

Further details of the implementation of the communications protocol 310 using object-oriented techniques are set out in Tables 1, 2 and 3 below. Java™, Smalltalk™ and C++ are a few examples of object-oriented programming languages. In an object-oriented programming language, data and related methods can be grouped together (“encapsulated”) to form an entity known as an “object,” the fundamental building block of object-oriented programming. The data structures within an object may alternately be referred to as the object's state, its properties, its attributes, its fields, or its variables. In the Java language, the data structures are normally referred to as the variables of the object. In the Smalltalk object-oriented programming language, the data structures may be normally referred to as the properties of the object. The procedures that operate on the variables are referred to in Java and Smalltalk as the methods of the object. The list of methods, associated with the object, may also be referred to as the list of operations. Unlike traditional programming, in object-oriented programming the operations on the variables may only be performed via the methods of the object. The properties and methods of an object may all be referred to as the members of the object.

When the properties relating to an object and the methods that might affect the object are encapsulated within the object, other entities usually do not have direct access to these data and procedures. The other entities instead call on the object itself to invoke its own methods and thereby operate on its own data. The encapsulation of the members of the object thereby provides some protection for the data within the object and prevents unauthorized, unwanted, or unintended manipulation of the data. This is sometimes referred to as data hiding. (The concept of data hiding through encapsulation should be distinguished from the hiding of properties in Java variable declarations, as explained in more detail below.)

In the Java language, if a user wants to hide the data within an object, the variable that contains the data is made private. Private properties within an object may only be accessed by the methods of the object. Because it may, in some cases, be inconvenient or impractical to require manipulation of certain data through the methods of the associated object, some properties may be made public. These public properties are directly accessible to entities other than the object with which the properties are associated. Thus, in practice, the properties within objects normally include some that are hidden or inaccessible and some that are public.

All objects in an object-oriented programming system belong to a class, which can be thought of as a category of like objects, which describes the characteristics of those objects. Each object is created as an instance of the class by a program. The objects may therefore be said to have been instantiated from the class. The class sets out properties and methods for objects that belong to that class. The definition of the class does not itself create any objects. The class may define initial values for its properties, and the class normally defines the methods associated with the class (i.e., includes the program code which is executed when a method is invoked.) The class may thereby provide all of the program code that will be used by objects in the class, hence maximizing re-use of code, which is shared by objects in the class.

Problem solving may be accomplished by sending message(s) to objects. A message may name a method and may optionally include other arguments associated with the method. When a message is sent to an object, the method is looked up in the object's class to find out how to perform that operation on the given object. If the method is not defined for the object's class, it may be looked for in its parent's class and so on up the class hierarchy until it is found or there is no higher parent class.

Table 1 immediately below sets out one embodiment of the subscriber identity protocol 330 of FIG. 3. In this embodiment, the subscriber identity protocol 330 includes two objects, a ServiceProviderProtocol object and a SubscriberProtocol object, as shown.

TABLE 1
Subscriber Identity Protocol

```
    public interface ServiceProviderProtocol
      {
```

| | |
|---|---|
| ServiceProviderInfo getServiceProviderInfo( ) | // get the service provider information |
| throws RemoteException; | |
| SubscriberProtocol getSubscriberProtocol( ) | // get the subscriber protocol object |

```
            throws ServiceProviderAccessDeniedException;
        ContentDelivery getContentDeliveryProtocol( ); // get content delivery protocol object
            throws ServiceProviderAccessDeniedException;
```

| | |
|---|---|
| ContentBilling getContentBillingProtocol( ); | // get the billing protocol object |

```
            throws ServiceProviderAccessDeniedException;
        public ServiceProvider loginProvider(ServiceProvider client, String password)
// login the provider
            throws
                ServiceProviderAccessDeniedException;
        public boolean logoutProvider( ) // logout the provider
            throws RemoteException;
    }
    public interface SubscriberProtocol
    {
        public SubscriberInfo validateSubscriber (String subscriberID, String password)
            throws
                ServiceProviderInvalidException,
                SubscriberInvalidException,
                SubscriberAccessDeniedException,
                RemoteException;
        public ServiceProvider getServiceProvider(String providerName)
            throws
                ServiceProviderInvalidException;
    }
```

The ServiceProviderProtocol object includes four methods, the getServiceProviderInfo( ) method, the getSubscriberProtocol( ) method, the getContentDeliveryProtocol( ) method and the getContentBillingProtocol( ) method, as shown in Table 1. The getServiceProviderInfo( ) method is used to get information about other providers included in the TV services delivery system 100. The getSubscriberProtocol( ) method is used to get information about other subscribers included in the TV services delivery system 100 and is used with the subscriber protocol object. The getContentDeliveryProtocol( ) method is used to get information about the delivery of program content to subscribers included in the TV services delivery system 100, and is used with a content delivery protocol object described in Table 2 herein below. The getContentBillingProtocol( ) method is used to get information about billing information for subscribers and providers included in the TV services delivery system 100, and is used with a content billing protocol object described in Table 3 herein below.

Similarly, the SubscriberProtocol object includes two methods, the validateSubscriber method and the getServiceProvider method, as shown in Table 1. The validateSubscriber method is used in the authentication of subscribers included in the TV services delivery system 100. The getServiceProvider method is used to get information about providers included in the TV services delivery system 100.

Table 2 immediately below sets out one embodiment of the content delivery protocol 340 of FIG. 3. In this embodiment, the content delivery protocol 340 includes a definition of a ContentDelivery protocol object, as shown.

TABLE 2
Content Delivery Protocol

```
    public interface ContentDelivery
    {
        public boolean redirectContent (ServiceProvider sp, ContentInfo
ci, DestinationInfo di, SubscriberInfo si)
            throws
                SubscriberAccessDeniedException,
                ContentNotAvailableException,
                ContentNotFoundException,
                ContentNotRedirectableException,
                InvalidDestinationException,
                DestinationNotCompatibleException,
                RemoteException;
        public ChannelInfo[ ] listChannelsAvailable(ServiceProvider sp,
        SubscriberInfo si);
        public ContentInfo[ ] listContentAvailable(ServiceProvider sp,
SubscriberInfo si, ChannelInfo ci, Date starting, Date ending)
            throws
                SubscriberAccessDeniedException,
                InvalidDateRangeException,
                RemoteException;
        public DestinationInfo getCurrentDestination(ContentInfo ci)
            throws
                InvalidContentInfoException,
                RemoteException;
        public boolean cancelRedirection(ContentInfo ci)
            throws
                    InvalidContentInfoException,
                    RemoteException;
        public ContentInfo[ ] getCurrentRedirections(SubscriberInfo si)
            throws
                    SubscriberInfoInvalidException,
                RemoteException;
    }
```

Table 3 immediately below sets out one embodiment of the content billing protocol 350 of FIG. 3. In this embodiment, the content billing protocol 350 includes a definition of a ContentBillingProtocol object, as shown.

TABLE 3
Content Billing Protocol

```
        public interface ContentBillingProtocol
        {
                public boolean billForContent(ServiceProvider sp, ContentInfo ciReplacement,
DestinationInfo di, SubscriberInfo si)
                    throws
                        InvalidContentException,
                        InvalidDestinationException,
                        RemoteException;
        }
    // The details of the objects such as SubscriberInfo, ServiceProviderInfo,
    // DestinationInfo, ContentInfo, ChannelInfo are implemenation dependent.
        public class ServiceProviderInfo
        {
            String getName( ); // name of company
            String getAddress( ); // street address
            String getPhone; // phone address
            String getEmail( ); // email address
            String getIpAddress( ); // IP of the service
                String getPort; // port of the service
                String getLicenseNumber( ); // federal license number
        }
        public interface SubscriberInfo
            {
            String getName( ); // name of company
            String getAddress( ); // street address
            String getPhone; // phone address
            String getEmail( ); // email address
            DestinationInfo getHomeDestination( ); // home cable terminal
        }
        public class ContentInfo
        {
            ChannelInfo getChannel( ); // channel information
                Date getStartingTime( ); // start time of content
                Date getEndTime( ); // end time of content
                String getDescription( ); // description of content
            String getRating( ); // the viewer rating of content (G, PG)
            String getQualityRating( ); // 1-5 stars.
            String getCategory( ); // category
        }
        public class DestinationInfo
        {
            String getName( ); // name of company
            String getAddress( ); // street address
            String getPhone; // phone address
            String getEmail( ); // email address
            String getTerminalID( ); // the terminal ID
        }
        public class ChannelInfo
        {
            String getMediumType( ); // broadcast medium (AM, FM, SAT, CABLE,CUSTOM,
INTERNET)
            String getDataType( );
    // datatype of the broadcast (RADIO, ANALOGVIDEO, DIGVID, MPEG, INTERACTIVE, ..)
            String getSource( ); // the source of the broadcast
            String getName( ); // get the channel name
            String getDescription( ); // get the description of the channel
            String getBroadcasterName( ); // broadcaster name
                String getBroadcastFrequency( ); // frequency
            String decoderInfo( ); // decoder info
        }
```

Referring to FIG. 4, a computer system 410 is shown that is generally applicable for the various computer systems described above, according to an embodiment of the present invention. The system 410 includes a processor 415, a volatile memory 420, e.g., RAM, a keyboard 425, a pointing device 430, e.g., a mouse, a nonvolatile memory 435, e.g., ROM, hard disk, floppy disk, CD-ROM, and DVD, and a display device 405 having a display screen. Memory 420 and 435 are for storing program instructions, which are executable by processor 415, to implement various embodiments of a method in accordance with the present invention. Components included in system 410 are interconnected by bus 440. A communications device (not shown) may also be connected to bus 440 to enable information exchange between system 410 and other devices.

In various embodiments system 410 takes a variety of forms, including a personal computer system, mainframe computer system, workstation, Internet appliance, PDA, an embedded processor with memory, etc. In one embodiment, the computer system 170, the first provider 130, the first converter 120, the second provider 135 and the second converter 125 may be implemented as an embodiment of system 410.

That is, it should be understood that the term “computer system” is intended to encompass any device having a processor that executes instructions from a memory medium. The memory medium preferably stores instructions (also known as a “software program”) for implementing various embodiments of a method in accordance with the present invention. In various embodiments the one or more software programs are implemented in various ways, including procedure-based techniques, component-based techniques, and/or object-oriented techniques, among others. Specific examples include XML, C++ objects, Java and Microsoft Foundation Classes (MFC). For example, in one embodiment, the communications protocol 310 described in FIG. 3 may be implemented using Java based object-oriented techniques or in traditional C code.

From the above it should be appreciated that the invention advantageously provides a system and method that allows a consumer of TV services to redirect or forward at least a portion of the subscribed and paid for services. Furthermore, it is advantageous that the consumer can redirect the service on either a scheduled or a demand basis.

The description of the present embodiments have been presented for purposes of illustration, but are not intended to be exhaustive or to limit the invention to the forms disclosed. Many additional aspects, modifications and variations are also contemplated and are intended to be encompassed within the scope of the following claims. For example, while certain aspects of the present invention have been described in the context of TV entertainment services, those of ordinary skill in the art will appreciate that the processes of the present invention are capable of being applied to a variety of targeted services such as distance learning.

Also, the processes of the present invention are capable of being distributed in the form of a computer readable medium of instructions in a variety of forms. The present invention applies equally regardless of the particular type of signal bearing media actually used to carry out the distribution. Examples of computer readable media include RAM, flash memory, recordable-type media such as a floppy disk, a hard disk drive, a ROM, CD-ROM, DVD and transmission-type media such as digital and/or analog communication links, e.g., the Internet 180.

To reiterate, many additional aspects, modifications and variations are also contemplated and are intended to be encompassed within the scope of the following claims. Moreover, it should be understood that in the following claims actions are not necessarily performed in the particular sequence in which they are set out.

What is claimed is:

1. A method for providing TV services to a subscriber, wherein the services are selectively transportable, the method comprising:
a) receiving, by a first TV services provider, a first request from the subscriber, wherein the subscriber subscribes to a list of predefined channels included in the services, the predefined channels being delivered to a first location, and wherein the first request identifies a selected set of ones of the predefined channels and a selected converter located at a second location to which the selected set is to be redirected, wherein the selected converter is identified by a tag;
b) identifying a second TV services provider serving the selected converter;
c) sending a second request to the second provider, the second request identifying the selected channels to be redirected to the selected converter; and
d) receiving a response from the second provider identifying which ones of the channels of the selected set are available for delivery by the second provider to the converter, wherein a comparison of the available channels to the channels of the selected set indicates whether all of the selected channels are available for delivery by the second provider.

2. The method of claim 1, comprising the step of:
e) sending a reply to the second provider responsive to an indication from step d) that at least one of the selected channels is not available.

3. The method of claim 2, wherein the reply of e) includes program content for at least some of the indicated unavailable channels.

4. The method of claim 2, wherein the reply of e) includes program content for less than all of the indicated unavailable channels if available bandwidth of a network coupling the first and second providers is below a certain limit.

5. The method of claim 2, wherein the reply of e) comprises the step of:
requesting the second provider to offer a replacement channel to the subscriber in lieu of one of the channels requested for redirection if available bandwidth of a network coupling the first and second providers is below a certain limit.

6. The method of claim 1 comprising the step of the first provider authenticating the subscriber, wherein the authenticating includes the first provider communicating with a smart card of the subscriber

7. The method of claim 6, wherein the first provider communicates with the smart card via a network connected to a TV signal converter.

8. A computer program product for providing TV services to a subscriber, wherein the services are selectively transportable, the computer program product comprising:
first instructions for receiving, by a first TV services provider, a first request from the subscriber, wherein the subscriber subscribes to a list of predefined channels included in the services, the predefined channels being delivered to a first location, and wherein the first request identifies a selected set of ones of the predefined channels and a selected converter located at a second location to which the selected set is to be redirected, wherein the selected converter is identified by a tag;
second instructions for identifying a second TV services provider serving the selected converter;
third instructions for sending a second request to the second provider, the second request identifying the selected channels to be redirected to the selected converter;
fourth instructions for receiving a response from the second provider identifying which ones of the channels of the selected set are available for delivery by the second provider to the converter, wherein a comparison of the available channels to the channels of the selected set indicates whether all of the selected channels are available for delivery by the second provider.

9. The computer program product of claim 8, comprising:
fifth instructions for sending a reply to the second provider responsive to an indication arising from fourth instructions that at least one of the selected channels is not available.

10. The computer program product of claim 9, wherein the reply sent responsive to the fifth instructions includes program content for at least some of the indicated unavailable channels.

11. The computer program product of claim 9, wherein the reply sent responsive to the fifth instructions includes program content for less than all of the indicated unavailable channels if available bandwidth of a network coupling the first and second providers is below a certain limit.

12. The computer program product of claim 9, wherein the fifth instructions comprise instructions for requesting the second provider to offer a replacement channel to the subscriber in lieu of one of the channels requested for redirection if available bandwidth of a network coupling the first and second providers is below a certain limit.

13. The computer program product of claim 8 comprising sixth instructions for authenticating the subscriber, wherein the authenticating includes the first provider communicating with a smart card of the subscriber.

14. A system for providing TV services to a subscriber, wherein the services are selectively transportable, the system comprising:
a first converter at a first location operable to receive a first TV signal that includes TV programs or other content arranged by channels from a first TV services provider via a first communications link and to convert the signal to a format for a first TV set coupled to the converter;
a second converter at a second location operable to receive a second TV signal that includes TV programs or other content arranged by channels from a second TV services provider via a second communications link and to convert the second signal to a format for a second TV set coupled to the second converter, wherein the selected converter is identified by a tag;
a subscriber computer system located at at least one of the first and second locations and coupled to a network, the computer system being operable via the network for the subscriber to communicate with at least the first provider, wherein the subscriber subscribes to a list of predefined channels included in the services, the predefined channels being delivered to the first location;
a computer system for the first provider, coupled to the network, operable to communicate with the subscriber and a number of other TV service providers, including the second provider, and being programmed to perform the steps of:
a) receiving a first request from the subscriber, wherein the first request identifies a selected set of ones of the predefined channels and identifies the second converter, to which the selected set is to be redirected;
b) identifying the second TV services provider serving the selected converter;
c) sending a second request to the second provider, the second request identifying the selected channels to be redirected to the selected converter; and
d) receiving a response from the second provider identifying which ones of the channels of the selected set are available for delivery by the second provider to the converter, wherein a comparison of the available channels to the channels of the selected set indicates whether all of the selected channels are available for delivery by the second provider.

15. The system of claim 14, wherein the first provider's computer system is programmed to perform the steps of:
e) sending a reply to the second provider responsive to an indication from step d) that at least one of the selected channels is not available.

16. The system of claim 15, wherein the reply of e) includes program content for at least some of the indicated unavailable channels.

17. The system of claim 15, wherein the reply of e) includes program content for less than all of the indicated unavailable channels if available bandwidth of a network coupling the first and second providers is below a certain limit.

18. The system of claim 15, wherein the reply of e) comprises the step of:
requesting the second provider to offer a replacement channel to the subscriber in lieu of one of the channels requested for redirection if available bandwidth of a network coupling the first and second providers is below a certain limit.

19. The system of claim 14, wherein the first provider's computer system is programmed to perform the step of authenticating the subscriber.

20. The system of claim 14, wherein the subscriber computer system is included in the corresponding converter or TV set, and wherein the network over which the subscriber computer system is operable to communicate includes the same link that carries the TV signal.
